(19) United States
(12) Patent Application Publication
(10) Pub. No.: US 2019/0120370 A1
(43) Pub. Date: Apr. 25, 2019

(54) MULTI-FUNCTION VEHICLE CONTROL AND METHOD FOR VEHICLE CONTROL

(71) Applicant: STRATTEC SECURITY CORPORATION, Milwaukee, WI (US)

(72) Inventors: Steven J. Dimig, Plymouth, WI (US); Zachary S. Husz, West Allis, WI (US); Adam Pirkey, Germantown, WI (US)

(21) Appl. No.: 16/168,457

(22) Filed: Oct. 23, 2018

Related U.S. Application Data
(60) Provisional application No. 62/575,838, filed on Oct. 23, 2017.

(51) Int. Cl. F16H 59/12; F16H 59/02

(52) U.S. Cl. CPC F16H 59/12; F16H 2059/081; F16H 59/0278; F16H 59/0217

(57) ABSTRACT

A multi-function vehicle control for a vehicle having an interior surface and a transmission, the control including a shifter movable to different positions corresponding to different states of the transmission, and an elongate base extending from the interior surface laterally across a fore-aft direction of the vehicle and defining a driver-facing side. The elongate base movably supports the shifter for multiple movements of the shifter relative to the elongate base including: a first movement of the shifter along a longitudinal direction of the elongate base operable to control a first operation of the transmission; a second movement of the shifter away from the driver-facing side, in a forward vehicle travel direction operable to control a second operation of the transmission; and a third movement of the shifter toward the driver-facing side, in a rearward vehicle travel direction operable to control a third operation of the transmission.

### CROSS-REFERENCE TO RELATED APPLICATIONS

This application claims priority to U.S. Provisional Patent Application No. 62/575,838, filed on Oct. 23, 2017, the entire contents of which are incorporated by reference herein.

### BACKGROUND

The present disclosure relates to vehicle controls and methods for changing a vehicle control state. More specifically, the present disclosure relates to multi-function vehicle controls and control methods configured for changing a plurality of vehicle control states.

### SUMMARY

In some embodiments, a multi-function vehicle control includes an elongate body having a base portion and an end grip. The base portion has a proximal end and a distal end spaced apart from the proximal end along a longitudinal axis that extends through the proximal and distal ends. A start/stop actuator is supported by the body and operable to selectively enable and disable an active motor state that allows a vehicle having the multi-function vehicle control to be driven. The multi-function vehicle control further includes a dial supported by the elongate body about a dial axis that is neither coaxial, nor parallel with the longitudinal axis of the base portion. The dial is rotatable about the dial axis to a plurality of rotational positions to change a vehicle control state.

In some embodiments, the end grip is slidably coupled to the base portion.

In some embodiments, the dial may be translatable along the dial axis between at least a first translational position and a second translational position to change between at least two vehicle control contexts.

In some embodiments, the dial is rotatable to change a first vehicle control state when positioned in the first translational position, and rotatable to change a second vehicle control state when positioned in the second translational position. The vehicle control contexts may correspond to a drive mode vehicle control context, an assisted driving mode vehicle control context, an automatic start/stop mode vehicle control context, or any other vehicle control context comprising a plurality of related vehicle control states.

In some embodiments, a method of operating a multi-function vehicle control includes receiving an input on a start/stop actuator provided on a body of the control to enable an active motor state that allows a vehicle having the control to be driven. A rotational input is received to a dial supported on the body about a first axis within the body to change a first vehicle control state. The first axis is neither coaxial, nor parallel with a longitudinal axis defined by the body.

In some embodiments, the method further includes receiving a rotational input to a control device supported by the body about a second axis to change a second vehicle control state, wherein the second axis is neither coaxial, nor parallel with the longitudinal axis; and expanding a part line between the control device and the body, by movement along the longitudinal axis, to change a third vehicle control state.

In some embodiments, a multi-function vehicle control includes an elongate body having a base portion including a proximal end and a distal end spaced from the proximal end along a longitudinal axis that extends through the proximal end and the distal end. A shifter is movably supported on the elongate body to provide a plurality of transmission control positions, including at least a reverse position and a drive position. A dial is supported by the elongate body about a dial axis that is neither coaxial, nor parallel with the longitudinal axis. The dial is rotatable about the dial axis to a plurality of rotational positions to change a vehicle control state.

In some embodiments, a method of operating a multi-function vehicle control includes receiving an input on a shifter provided on a body of the control to change a state of a transmission of the vehicle between at least a reverse state and a drive state; and receiving a rotational input to a dial supported on the body about a first axis within the base portion body to change a first vehicle control state, the first axis being neither coaxial, nor parallel with a longitudinal axis defined by the body.

In some embodiments a vehicle control module includes an elongate body, an end grip, and a wireless transceiver. The elongate body defines a proximal end of the vehicle control module. The end grip defines a distal end of the vehicle control module. The end grip is slidably supported by the elongate body and spaced apart from the elongate body along a longitudinal axis extending through the elongate body. The wireless transceiver is located within the elongate body.

In some embodiments, a method of changing an operational state of a vehicle includes supporting a wireless transceiver within an elongate body that extends from a support surface, receiving a wireless signal by the wireless transceiver from a wireless electronic device, and controlling the operational state of the vehicle based at least in part on the wireless signal. The wireless transceiver is disposed proximate a lower surface of the body. The wireless signal is received when the wireless electronic device is within range of the wireless transceiver. In some embodiments, the wireless electronic device is positioned proximate the lower surface of the elongate body to promote signal reception.

In some embodiments, a multi-function vehicle control includes an elongate portion forming a base of the control and configured to project outward from a vehicle interior surface. A shifter extends from the elongate base portion, the shifter configured for slidable displacement to a plurality of positions relative to the elongate base portion to electronically select transmission operating states. The shifter is yieldably detained in each of the plurality of positions so that each corresponds to a respective transmission operating state. At least one additional control element is supported on the elongate portion and operable to provide selection of vehicle control states within a context unrelated to the transmission operating state.

In some embodiments, a method for operating a multi-function vehicle control includes slidably displacing an electronic shifter by a user's hand, surroundably engaging a portion of the electronic shifter, from a first position to a second position. The electronic shifter extends from an elongate stationary member and is configured for changing a first vehicle control state. An input is received to a dial disposed on the elongate stationary member from the user's hand while the user's hand surroundably engages the portion of the electronic shifter.

In some embodiments, a multi-function vehicle control includes a proximal portion and an end grip extending from the proximal portion. The vehicle control includes a first state in which the proximal portion and end grip define a continuous contoured surface extending across a part line between the proximal portion and the end grip. The vehicle control also includes a second state in which the proximal portion and the end grip define a discontinuous contoured surface. The end grip is yieldably detained in both the first state and the second state. In some embodiments, the vehicle control includes a third state in which the end grip is displaced with respect to the proximal portion in a direction perpendicular to the second state. In some embodiments, the end grip is prevented from displacement to the third state when displaced in the second state.

In some embodiments, a multi-function vehicle control includes a proximal portion and an end grip. The end grip is movably coupled to the proximal portion via a displaceable connection defining at least two different positions of the end grip with respect to the proximal portion corresponding to at least two respective vehicle control states in a first vehicle control context. The vehicle control may further include a dial for controlling a vehicle control state in a second vehicle control context.

In some embodiments, a multi-function vehicle control includes a paddle-shaped housing including a proximal portion and an end grip having a front surface and a rear surface configured for articulation by a user's hand. The end grip is movable with respect to the proximal portion between different positions corresponding to at least two different vehicle control states in a first vehicle control context. In some embodiments, the end grip is yieldably detained in each of the at least two different positions. In some embodiments, the vehicle control further includes a dial disposed on the paddle-shaped housing for controlling a vehicle control state in a second vehicle control context.

In some embodiments, a method for operating an elongate vehicle control includes detecting a proximate relationship between a low frequency coupler and a transceiver, authorizing an active motor state, activating the active motor state, detecting a movement of an end grip, and transitioning from a disabled transmission operating state to an enabled transmission operating state (e.g. a state in which a parking pawl is disengaged). The vehicle control includes a proximal portion and an end grip, the end grip movable with respect to the proximal portion between a disabled transmission operating state position and an enabled transmission operating state position. The transceiver is located within the elongate multi-function vehicle control. The authorizing occurs while the end grip is in the disabled transmission operating state based, at least in part, on an identifier of the low frequency coupler. The detected movement of the end grip is a movement from the disabled transmission operating state position to the enabled transmission operating state position. The transitioning from the disabled transmission operating state to the enabled transmission operating state occurs while the active motor state is activated. In some embodiments, the method for operating an elongate vehicle control further includes detecting movement of the end grip from the enabled transmission operating state position to an active transmission operating state position corresponding to an active transmission operating state (e.g. a Drive or Reverse vehicle control state).

In some embodiments, the invention provides a method of electronically shifting among operating states of a vehicle transmission with a shifter. An elongate base is provided extending from a vehicle interior surface and defining a driver-facing side. The elongate base movably supports the shifter for movement in a fore-aft direction of the vehicle. The shifter is displaced at least partially along a longitudinal direction of the elongate base to disengage a park operating state of the transmission. The shifter is displaced away from the driver-facing side, in a forward travel direction of the vehicle to engage a forward drive state of the transmission. The shifter is displaced toward the driver-facing side, in a rearward travel direction of vehicle, to engage a reverse drive state of the transmission.

In some embodiments, a multi-function vehicle control for a vehicle interior having an interior surface and a transmission includes a shifter movable to different positions corresponding to different states of the transmission; and an elongate base extending from the interior surface and defining a driver-facing side, the elongate base movably supporting the shifter for movement in a fore-aft direction of the vehicle; wherein the shifter is movable along a longitudinal direction of the elongate base to and from a position corresponding to a park operating state of the transmission; wherein the shifter is also movable away from the driver-facing side, in a forward travel direction of the vehicle corresponding to a forward drive state of the transmission; and wherein the shifter is also movable toward the driver-facing side, in a rearward travel direction of the vehicle corresponding to a reverse state of the transmission.

In some embodiments, a non-transitory computer-readable medium stores instructions that, when executed by a processor of a computer, cause the computer to execute operations including detecting a proximate relationship between a low frequency coupler and a transceiver, authorizing an active motor state, activating the active motor state, detecting a movement of an end grip, and transitioning from a disabled transmission operating state to an enabled transmission operating state. The vehicle control has an elongate shape, including a proximal portion and an end grip, the end grip movable with respect to the proximal portion between a disabled transmission operating state position and an enabled transmission operating state position, corresponding to a disabled transmission operating state and an enabled transmission operating state. The transceiver is located within the elongate multi-function vehicle control. The authorizing occurs while the end grip is in the disabled transmission operating state position based, at least in part, on an identifier of the low frequency coupler. The detected movement of the end grip may include detecting a movement of the end grip from the disabled transmission operating state position to the enabled transmission operating state position. The transitioning from the disabled transmission operating state to the enabled transmission operating state occurs while the active motor state is activated.

In some embodiments, a multi-function vehicle control includes a first control surface and a second control surface. The vehicle control includes a first position corresponding to a first vehicle control state in a first vehicle control context and a second position corresponding to a second vehicle control state in the first vehicle control context. The first control surface and the second control surface define a continuous contoured surface extending across a part line between the first control surface and the second control surface in the first position and a discontinuous contoured surface across the part line in the second position. The second control surface is yieldably detained in the first and second positions. The multi-function vehicle control may further include a dial disposed on the first control surface for selecting between a plurality of vehicle control states in a second vehicle control context. The multi-function vehicle control may further include at least one switch disposed on the second control surface for selecting between a plurality of vehicle control states in a third vehicle control context. In some embodiments, a vehicle control state indicator is visible within the part line in the second position. In some embodiments, the multi-function vehicle control further includes a haptic feedback operable to vibrate or provide tactile feedback to a user of the vehicle control confirming selection of a vehicle control state in at least one of the first, second, or third vehicle control contexts.

Other aspects of the invention will become apparent by consideration of the detailed description and accompanying drawings.

### BRIEF DESCRIPTION OF THE DRAWINGS

FIG. 1 is a perspective view of a multi-function vehicle control according to one embodiment.

FIG. 2 is a top view of the multi-function vehicle control of FIG. 1, illustrating a dial in a first position.

FIG. 3 is a top view of the multi-function vehicle control of FIG. 1, with the dial extended to a second position.

FIG. 4 is a top view of the multi-function vehicle control of FIG. 1, with an end grip slidably displaced in a first direction.

FIG. 5 is a top view of the multi-function vehicle control of FIG. 1, with the end grip slidably displaced in a second direction.

FIG. 6 is a top view of the multi-function vehicle control of FIG. 1, with the end grip translatably displaced in a third direction.

FIG. 7 is an exemplary installation of the multi-function vehicle control of FIG. 1 in a vehicle.

FIG. 8 is a flow diagram of a method of operating a vehicle control.

FIG. 9 is another flow diagram of a method of operating a vehicle control.

FIG. 10 illustrates a computer system for operating a vehicle control.

### DETAILED DESCRIPTION

Before embodiments of the present invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

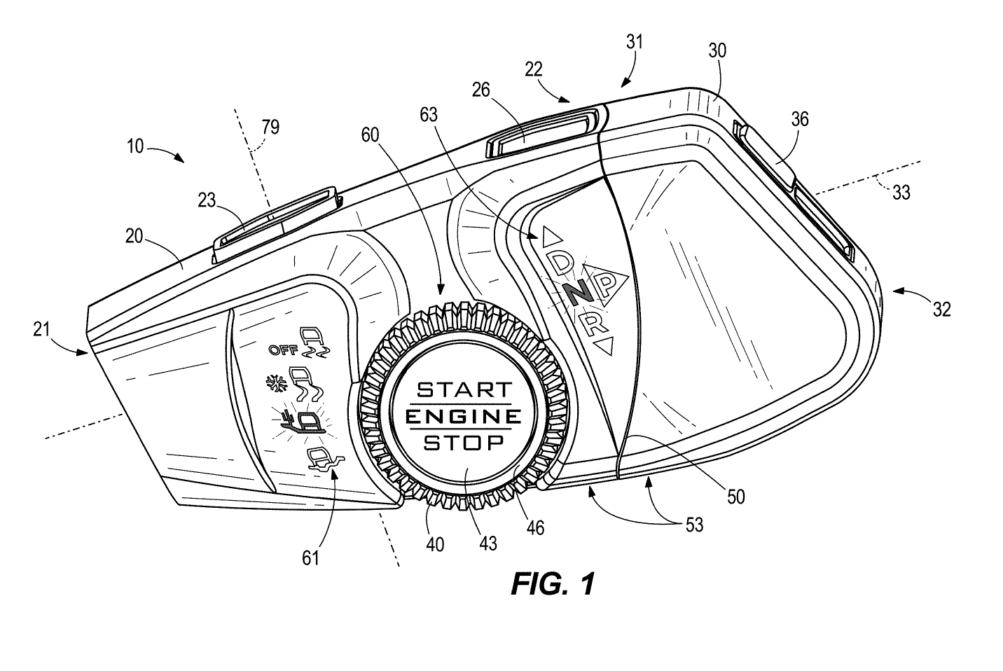

Referring to FIG. 1, a multi-function vehicle control 10 is shown in accordance with one exemplary embodiment of the present disclosure. More specifically, FIG. 1 illustrates the multi-function vehicle control 10 having a housing formed as an elongate body, for example, in a paddle-shape or stalk shape. The housing may form a cantilever from a support structure of a vehicle interior, and can be either fixed or movable as a lever with respect to the support structure. The housing includes a first control surface provided by a base portion 20, which is also referred to as a “body” or “proximal portion”, and a plurality of control devices supported by the base portion 20, such as a second control surface provided by an end grip 30, and a rotatable dial 40.

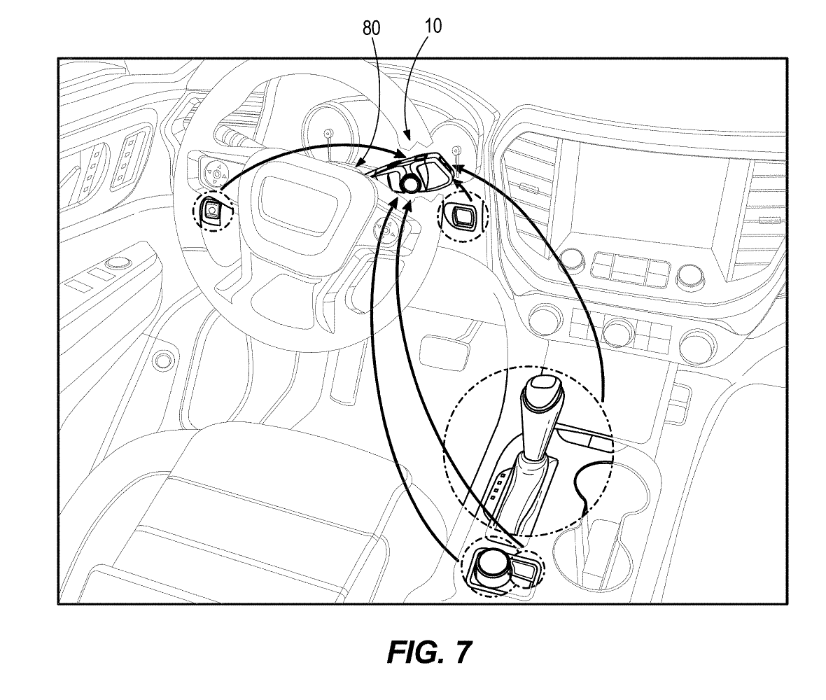

The base portion 20 may be configured or adapted to be fixedly secured within a vehicle, i.e. forming a stationary body. In some embodiments, the base portion 20 has an elongate shape, including a proximal end 21, a distal end 22, and a longitudinal axis 33 extending from the proximal end 21 through the distal end 22. The longitudinal axis 33 may be defined by a direction of maximum dimension and/or from the geometric form itself. The proximal end 21 may be supported adjacent a support surface, such as, for example, a steering column. The distal end 22 is located opposite the proximal end 21 along the longitudinal axis 33, and in the illustrated embodiment has an arcuate convex profile. Between the proximal end 21 and the distal end 22 is a top face, which may include one or more switch actuators, such as switch actuators 23, 26 (shown as push buttons). A front face of the base portion 20 may include one or more indicia of a vehicle control state, such as indicators 61 and 63. The front face may further include a recess 60 which at least partially encompasses or surrounds the dial 40. The base portion 20, and the control 10 as a whole, may extend in the cross-car direction C (FIG. 7). This means that the direction of elongation defined by the longitudinal axis 33 is predominantly in the cross-car direction C, though not necessarily perfectly parallel. The cross-car direction C is perpendicular to both a vertical direction V and a vehicle longitudinal (fore-aft) direction L. Orientations other than that shown in FIG. 7 are optional.

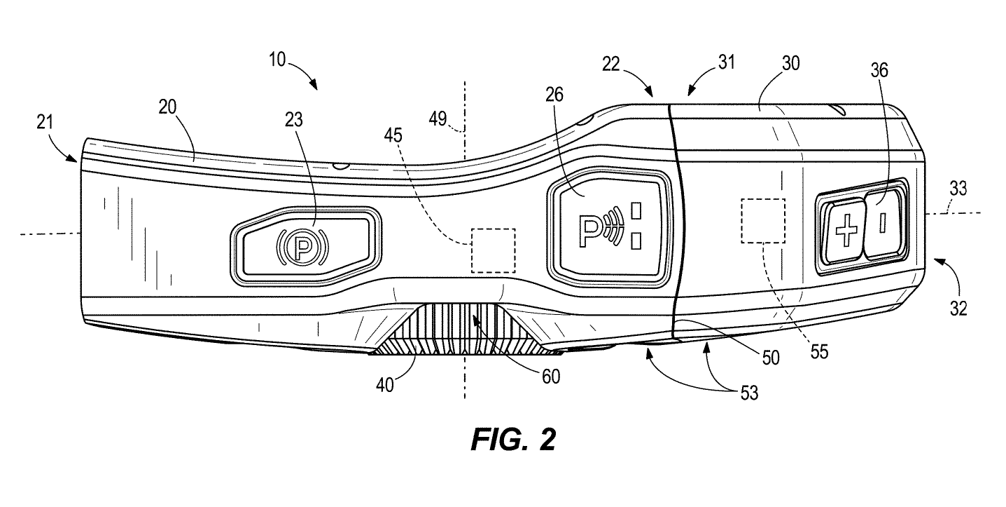

Extending along the longitudinal axis 33 of the base portion 20, the end grip 30 similarly has a proximal end 31 and a distal end 32. The proximal end 31 is located adjacent the distal end 22 of the base portion 20, and in the illustrated embodiment has an arcuate concave profile receptive to the arcuate convex profile of the distal end 22. The distal end 22 and the proximal end 31 collectively define a part line 50 between the base portion 20 and the end grip 30. When aligned, as shown in FIGS. 1-2, surfaces of the base portion 20 and the end grip 30, particularly the distal end 22 and the proximal end 31, define a common, or continuous, contoured surface 53 extending across the part line 50. The common contoured surface 53 can be formed by (for example) a compound curvature, and can extend around multiple sides of the vehicle control 10, e.g. any combination or all of the front, rear, top, and bottom sides.

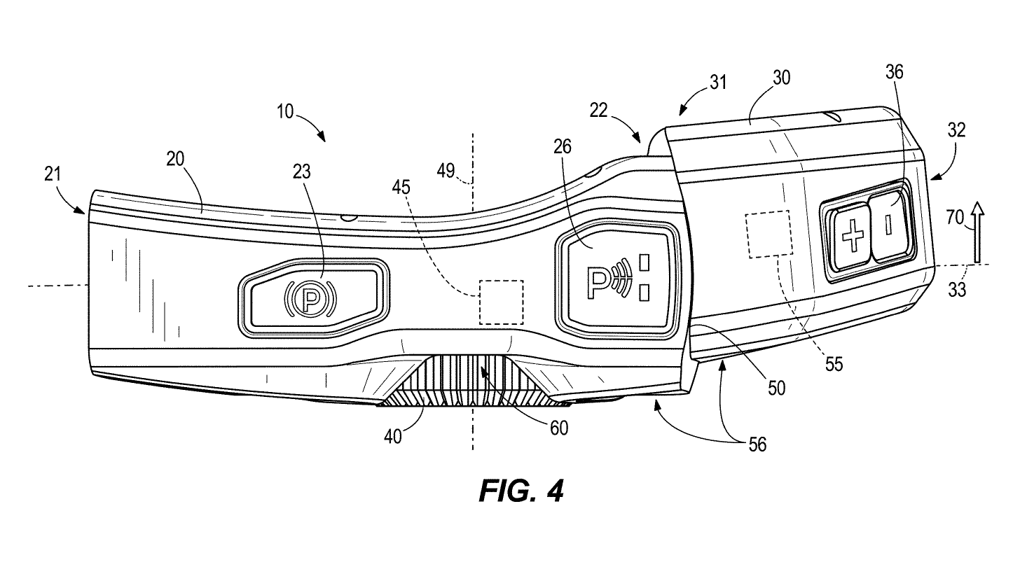

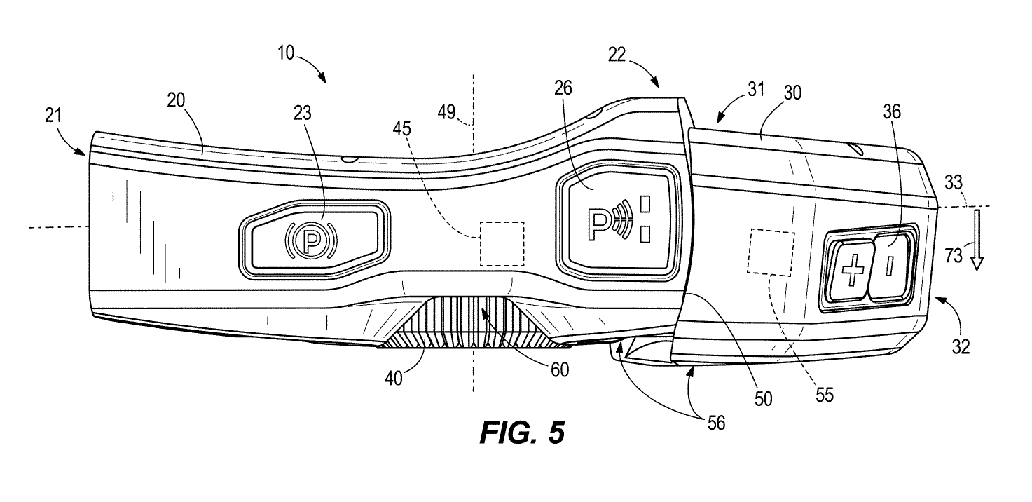

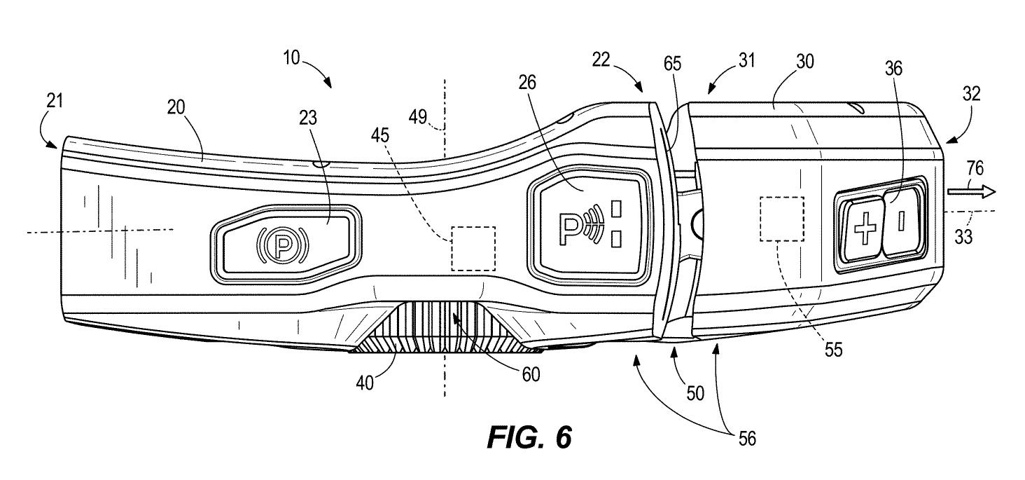

With continued reference to the illustrated embodiment, the end grip 30 is slidably supported by the base portion 20 where the base portion 20 meets the end grip 30 at the part line 50. The slidable support may be provided as a result of a hinge or pivot connection defining a pivot axis 79 that is spaced from the part line 50 toward the proximal end 21. When the axis 79 is located outside of the end grip 30, orbital displacement of the end grip 30 results, within a limited angular range (e.g., less than 90 degrees). In some constructions, including the illustrated embodiment, the pivot axis 79 is provided within the base portion 20 by a hinge connection or track connection, while in other constructions, a pivot axis that lies completely outside the physical boundary of the vehicle control 10 (e.g., beyond the proximal end 21) can be defined by a track connection. Slidable support may prohibit rotation of the end grip 30 about the longitudinal axis 33 while allowing displacement along or perpendicular to the longitudinal axis 33. The perpendicular displacement may form a linear or arcuate travel path, wherein the distal end 22 and the proximal end 31 maintain a relative distance across the part line 50 (e.g. the part line 50 stays closed). The end grip 30 may be displaced from a first position to a plurality of positions to change a vehicle control state, as explained below. The end grip 30 may be yieldably detained in each of the plurality of positions, e.g. by one or more detents (not shown). Movement of the end grip 30 with respect to the base portion 20 among the various positions in the yieldably detailed manner results in the shape of the vehicle control 10 being transformed among various configurations. For example, an overall three-dimensional packaging envelope defined by the exterior surfaces of the base portion 20 and the end grip 30 is different for each yieldably detained position of the end grip 30. As opposed to a self-centering momentary control, this enables a tactile and visual indication of the present state of the end grip 30 at any given time, whether the user is actively operating the control or not. The end grip 30 may be slidably displaced about the pivot axis 79 in one or more directions, as shown in FIGS. 4-5. Alternatively or additionally, the end grip 30 may be displaced in a direction along the longitudinal axis 33 as shown in FIG. 6, expanding the part line 50. The end grip 30 may include one or more switch actuators 36 configured to change a vehicle control state, as explained below. The end grip 30 may be shaped and/or textured to promote engaging between a user's hand and the end grip 30. For example, the end grip 30 may have a rubberized surface, or include contours shaped to surroundably receive a user's hand.

In some embodiments, the rotatable dial 40 is supported on the front face of the base portion 20. The dial 40 is operable or rotatable about a dial axis (e.g. dial axis 49 of FIG. 2-6) to change a vehicle control state. The dial 40 may include or surround, partially or entirely, a switch actuator 43 configured for changing a vehicle control state, as explained below. The dial 40 may also include a light ring 46 for selective or varied illumination (e.g., indicating a present vehicle control state). Alternatively, the light ring 46 can be provided in the switch actuator 43 or the front face of the base portion 20.

Within the base portion 20, a wireless transceiver 45 may be provided, such as, for example, a radio-frequency transceiver 45 configured for NFC, RFID, Bluetooth, or Wi-Fi communication. The wireless transceiver 45 may be located closer to a bottom face of the base portion 20, opposite the top face, for example, directly below the dial 40 and the switch actuator 43. A haptic feedback device 55, such as a vibration motor, may be operable to vibrate or provide tactile feedback to a user of the vehicle control 10 confirming selection of a vehicle control state. The haptic feedback device 55 may be provided in the end grip 30, as shown in FIGS. 2-6, or may be provided in the base portion 20.

Vehicle control states may be indicated or displayed by one or more indicia on a control surface, such as the base portion 20 or the end grip 30, of the vehicle control 10. On the front face of the base portion 20 and adjacent to the dial 40, a first indicator 61 is configured for displaying at least a present vehicle control state selected by the dial 40. Disposed adjacent to the end grip 30 on the front face of the base portion 20, an indicator 63 is configured for displaying at least a present vehicle control state selected by the end grip 30. In the present embodiment, the indicators 61 and 63 are shown as a collection of illuminable symbols, but may be a display screen, color-variable light source, another device capable of visually indicating a present vehicle control state, or any combination thereof.

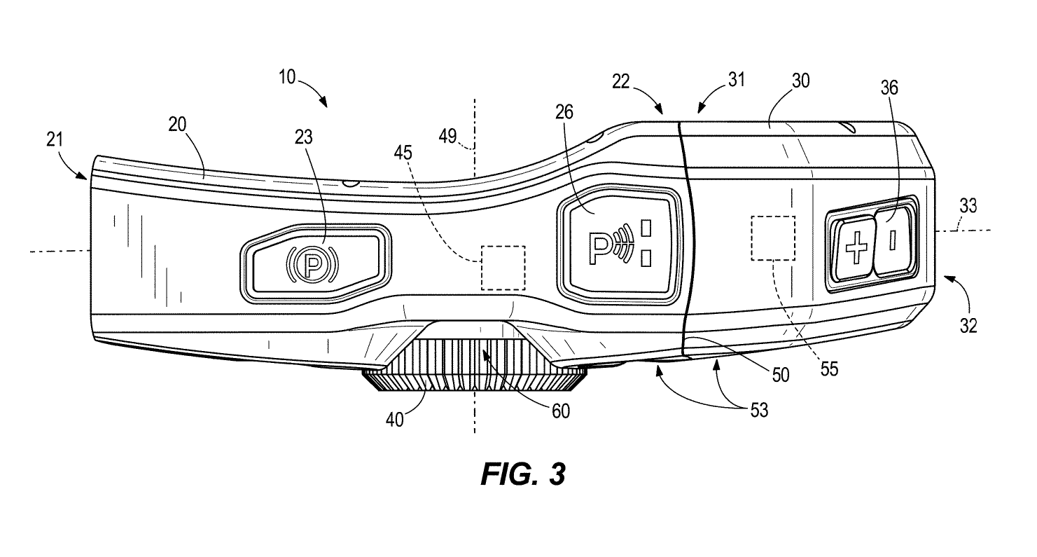

FIG. 2 more clearly shows the top face of the base portion 20, as well as the dial axis 49. The dial axis 49 may have an orientation that is not coaxial with, nor parallel to, the longitudinal axis 33. For example, the dial axis 49 can be oriented perpendicular to the longitudinal axis 33, or may be skewed therefrom. The dial 40 is located within the recess 60, which may decrease the likelihood of inadvertent rotation of the dial 40. For example, a portion or portions of a perimeter of the dial 40, in some cases constituting a majority thereof, can be partially or entirely nested in and/or shielded by the recess 60 to present limited accessibility for deliberate operation. In some embodiments, the dial 40 is translatable along the dial axis 49. Translation of the dial 40 may be configured to change a vehicle control context, as explained below, each comprising a plurality of selectable vehicle control states. As shown in FIG. 2, the dial 40 is located in a retracted or inward position corresponding to a first vehicle control context. As shown in FIG. 3, translation of the dial 40 along the dial axis 49 results in the dial 40 being located in an extended or outward position corresponding to a second vehicle control context.

FIGS. 4-6 illustrate various displacements of the end grip 30 relative to the base portion 20. As shown in FIG. 4, the end grip 30 may be displaced with respect to the base portion 20 in a first direction 70, which is perpendicular to the longitudinal axis 33 and away from the front face of the base portion 20. Although the end grip 30 may be displaced in the first direction 70, the travel path of the end grip 30 need not be exclusively along the first direction 70 (i.e. the travel path may be predominantly along the first direction 70, combined with a supplementary component of translation and/or rotation). After displacement from a first position to a second position in the first direction 70, the end grip 30 may be yieldably detained in the second position. In other words, the end grip 30 holds itself in position when the end grip 30 is released by a user. Similarly, as shown in FIG. 5, the end grip 30 may be displaced with respect to the base portion 20 to a third position in a second direction 73, which is perpendicular to the longitudinal axis 33 and toward the front face of the base portion 20. As with the travel path between the first and second positions, the travel path of the end grip 30 in the second direction 73 may include a supplementary component of translation and/or rotation. In fact, the travel path to the third position can be an extension of the travel path between the first and second positions. After displacement from the first position to a third position in the second direction 73, the end grip 30 may be yieldably detained in the third position. In some embodiments, whether the end grip 30 is supported by the base portion 20 for linear translation or a combination of translation and rotation, the end grip 30 is not supported for purely rotational motion about an axis internal thereto to remain in a single, fixed position on the base portion 20 when operated to the various positions. Rather, the end grip 30 is repositioned or displaced with respect to the base portion 20 to define each different operational position.

Alternatively or additionally, and with reference to FIG. 6, the end grip 30 may be displaced apart from the base portion 20 to a fourth position. The displacement of the end grip 30 to the fourth position can be in a third direction 76 along the longitudinal axis 33, and may optionally include a supplementary translational or rotational component. The displacement of the end grip 30 to the fourth position can extend the end grip 30 from the base portion 20 to increase an overall length of the control 10, as measured along the longitudinal axis 33. Likewise, the end grip 30 can be returned back to the first position of FIG. 3 by an equal and opposite displacement that functions as a retraction of the end grip 30 to the base portion 20 to reduce the overall length of the control 10, as measured along the longitudinal axis 33. After displacement from the first position to the fourth position, the end grip 30 may be yieldably detained in the fourth position. In some embodiments, the end grip 30 may be prevented from displacement in one or more directions when not in the first position. In some embodiments, displacement of the end grip 30 from the base portion 20 may be indicated by an indicator, such as an indicator 65, as shown in FIG. 6. The indicator 65 may be a region of contrasting color revealed when the end grip 30 is displaced, or the indicator 65 may be an illuminable portion which is selectively or variably illuminated.

As shown in FIGS. 4-6, the various displacements of the end grip 30 from the base portion 20 causes the continuous contoured surface 53 to be transformed into a discontinuous contoured surface 56 across the part line 50. The discontinuous contoured surface 56 may be a partial discontinuity where the continuous contoured surface 53 is maintained between one or more faces across the part line 50, for example as with the continuous top and bottom faces maintained in each of the shifted positions of FIGS. 4-5. Alternatively, the discontinuous contoured surface 56 may be a complete discontinuity, wherein the continuous contoured surface 53 is not maintained between any faces, as shown by the discontinuous contoured surface 56 in FIG. 6, which encircles the part line 50.

Control of a vehicle can generally be deconstructed into a plurality of vehicle control contexts, such as, for example, drive mode control contexts, transmission operating state control contexts, user comfort control contexts, media control contexts, security control contexts, and the like. Each vehicle control context may include one or more vehicle control states which may be exclusive to the parent control context, or may be shared amongst multiple contexts. Vehicle control states may be independent (e.g. influenced exclusively by a single user control) or dependent (i.e. influenced by one or more other vehicle states). A vehicle control state may have a binary value (i.e. on or off), a finite range of values, or may exhibit gradation (e.g. a rotational speed of a motor or engine).

For example, a vehicle may have starting system vehicle control context which includes an inactive control state, in which the starting system is off, and an active control state, in which one or more of the components, such as a radio or a motor, of a vehicle are enabled. In the case that the motor is enabled (though not necessarily delivering power to the wheels), an active control state may also be referred to as an “active motor state”. An active motor state can refer to a running internal combustion engine or an electric motor in a “ready” state, for example. In the illustrated construction, the switch actuator 43 is provided as a “start/stop” actuator, or so-called “start button”, operable to selectively enable and disable the active motor state of the vehicle. Some vehicles may further have one or more of an accessory control state, an auto start/stop control state, and an ignition control state. Some of these vehicle control states may be mutually exclusive (e.g. the inactive control state), whereas others may be active with or dependent upon another starting system vehicle control state. The auto start/stop control state may be binary, or may include a plurality of states, such as a variable delay start/stop control state. Different vehicle configurations (i.e. internal combustion, hybrid, electric, fuel cell, etc.) may use more or fewer starting system control states, or may combine aspects of multiple states.

As an example use case, in some embodiments, a multi-function vehicle control 10 may be configured so that the end grip 30 corresponds to a transmission operating state control context, including vehicle control states Neutral, Drive, Reverse, and Park. The position of the end grip 30 corresponds to respective vehicle control states. Initially, the end grip 30 is yieldably detained in the fourth position, apart from the base portion 20 along longitudinal axis 33, corresponding to the Park vehicle control state, wherein the transmission is in a disabled transmission operating state. While the vehicle is in an active motor state, a user may displace the end grip 30 from the fourth position along the longitudinal axis 33 toward the base portion 20 into the first position, corresponding to the Neutral vehicle control state, wherein the transmission is in an enabled transmission operating state, that being one which allows rotation and movement of the vehicle. This movement may further be enabled by a user's foot depressing a brake pedal to deactivate a shift lock-out device. In the first position, the base portion 20 and the end grip 30 form the common contoured surface 53 across the part line 50. The end grip 30 is yieldably detained in the first position until the user displaces the end grip 30. From the first position, a user may displace the end grip 30 in the first direction 70 to the second position, corresponding to a Drive vehicle control state, wherein the transmission is in an enabled transmission operating state, that being one which allows drive power through the transmission for forward propulsion of the vehicle. While the end grip 30 is yieldably detained in the second position, the user may actuate one or more switch actuators 36 to manually elect to upshift or downshift.

Alternatively, from the first position (Neutral), the user may displace the end grip 30 in the second direction 73 to the third position, corresponding to a Reverse vehicle control state, wherein the transmission is in an enabled transmission operating state, that being one which allows drive power through the transmission for backward propulsion of the vehicle. This process may be reversed, wherein the user displaces the end grip 30 from the second (Drive) or the third (Reverse) positions to the first (Neutral) position. From the first position, the user can displace the end grip 30 along the longitudinal axis 33, bringing the end grip 30 back to the fourth (Park) position. The displacement of the end grip 30 can be an axial displacement or a non-axial displacement having at least a component, and perhaps a majority component, along the longitudinal axis 33.

By way of example, in some embodiments, two switch actuators 23 and 26 of the multi-function vehicle control 10 may correspond to parking brake and parking assist vehicle control states, respectively. The switch actuator 23 may be configured as to be visible above the top face of the base portion 20 when actuated, to indicate that a parking brake has been applied. When the end grip 30 is in the fourth (Park) position, the user may depress the switch actuator 23 to engage the parking brake, although the switch actuator 23 can also have an emergency brake function that will apply braking during motion of the vehicle in the event of a failure of the vehicle's foundation brakes. Once the user releases the switch actuator 23, the switch actuator 23 may be maintained in a position above the top face of the base portion 20, until the user disengages the parking brake by depressing the switch actuator 23 a second time. The switch actuator 23 can be reached and operated by the hand of a user while the user's hand surroundably engages a portion of the end grip 30.

Similarly, the switch actuator 26 may be actuated to activate or deactivate a parking assist vehicle control state. A difficulty of parking experienced by the user can be reduced by the parking assist vehicle control state. The parking assist vehicle control state may use a plurality of sensors, such as cameras, vehicle controls, such as a steering control, and indicators, such as a display screen to detect and relay information to the user, as well as direct the vehicle controls based, at least in part, on information from the sensors. In an exemplary parallel parking scenario, the user aligns a vehicle adjacent to a parking spot and then actuates switch actuator 26 to activate the parking assist vehicle control state. The user may then displace the end grip 30 to the second (Drive) or third (Reverse) positions, based on the relative position and orientation of the user's vehicle to the parking spot. The parking assist vehicle control state then directs the vehicle controls and notifies a user when to displace the end grip 30 to the opposite (Second/Third) position. The user then displaces the end grip 30 and the process repeats until the user's vehicle is satisfactorily aligned in the parking spot, at which point the user may place the end grip 30 in the first (Neutral) position, and actuate the switch actuator 26 to deactivate the parking assist vehicle control state, or simply put the end grip 30 into the fourth Park position to conclude the parking maneuver and park the vehicle. The switch actuator 26 can be reached and operated by the hand of a user while the user's hand surroundably engages a portion of the end grip 30.

In the illustrated embodiment of FIG. 1, the dial 40 is rotatable to a plurality of positions corresponding, for example, to a plurality of stability control states in a drive mode vehicle control context. The stability control states can include “Off”, “Snow”, “Sand”, and “Rock”. The dial 40 may be retained along the dial axis 49, or may be translatable to a plurality of translational positions, wherein the dial 40 is rotatable in each translational position to a plurality of rotational positions corresponding to respective vehicle control states. The vehicle control states may all be encompassed within a single vehicle control context, or may be grouped into multiple vehicle control contexts based on the translational position.

For example, a first translational position of a dial 40, as shown in FIGS. 1-2, corresponds to a plurality of stability control states or stability control programs as an exemplary drive mode vehicle control context, and a second translational position of the dial 40, as shown in FIG. 3, corresponds to a plurality of assisted driving control states in an assisted driving mode vehicle control context. When in the first translational position of FIG. 2, the dial 40 is rotatable to select from a plurality of stability control states, including “Off”, “Snow”, “Sand”, and “Rock”. The current stability mode is displayed by the indicator 61. When in the second translational position, the dial 40 is rotatable to selectively enable or disable any number of a plurality of assisted driving modes, such as cruise or adaptive cruise control, automatic braking, lane-keep, sign recognition, steering assist, traction control, etc. Enabled assisted driving modes may be indicated by the indicator 61.

FIG. 7 illustrates an exemplary installation of the vehicle control 10 installed in a vehicle, supported by a steering column 80. As illustrated, vehicle control 10 may centralize control of various vehicle control states from a plurality of conventional vehicle buttons, shifters, levers, and dials (represented by arrows in FIG. 7). This centralization may improve user operation of the vehicle, as groups of related functions, such as those relevant at the beginning or end of a journey, are not located on disparate surfaces about the cabin. For example, a user may start a vehicle by depressing the switch actuator 43, disable a parking brake by actuating the switch actuator 23, and transition the vehicle from “Park” to “Drive” by displacing the end grip 30, all with one hand and without reaching to multiple locations about the cabin or without even necessarily re-positioning the hand on the single vehicle control 10. Additionally, the vehicle control 10 may free up space or reduce design constraints within the cabin that were previously imposed by conventional vehicle buttons, shifters, levers, and dials, particularly on an instrument panel and/or center console.

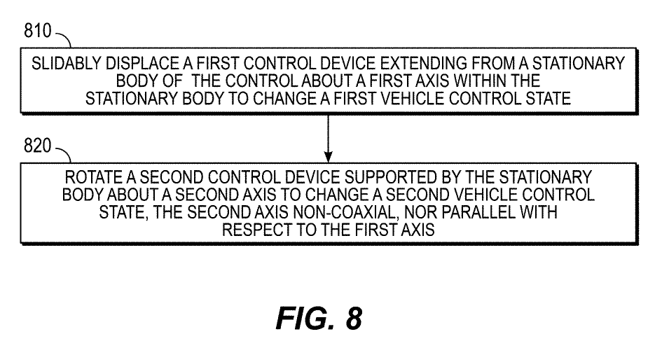

As shown in FIG. 8 in combination with the illustrated embodiment of FIGS. 1-7, a first control device, such as the end grip 30, may extend from a stationary body, such as the base portion 20. The first control device is slidably displaced about a first axis, such as the pivot axis 79, within the stationary body to change a first vehicle control state (Block 810). A second control device supported by the stationary body, such as the dial 40, is rotated about a second axis, such as dial axis 49, to change a second vehicle control state, wherein the second axis is neither coaxial, nor parallel with the first axis (Block 820).

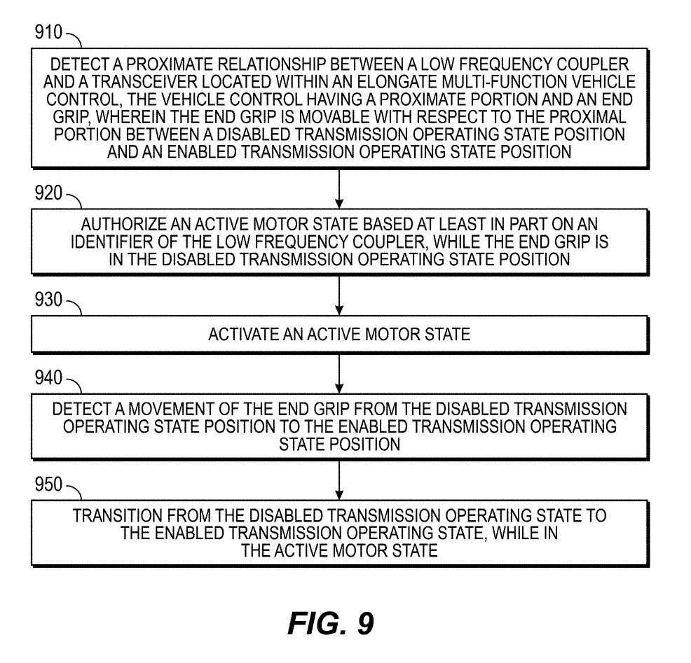

As shown in FIG. 9, a proximate relationship between a low frequency coupler and a transceiver 45 is detected (Block 910). The transceiver 45 is located within an elongate multi-function vehicle control 10, having a base portion 20 and an end grip 30, the end grip 30 movable with respect to the base portion 20 between a disabled transmission operating state position and an enabled transmission operating state position. Based at least in part on an identifier of the low frequency coupler, an active motor state is authorized, while the end grip 30 is in the disabled transmission operating state position (Block 920). The active motor state is activated (block 930). A movement of the end grip 30 from the disabled transmission operating state position to the enabled transmission operating state position is detected (Block 940). Finally, while in the active motor state, the disabled transmission operating state is transitioned to the enabled transmission operating state (Block 950).

Some other examples of vehicle control contexts and their respective vehicle control states are drive mode vehicle control contexts, including “Weather”, “Eco”, “Tour”, “Sport”, and “Track” control states; ergonomic vehicle control contexts, including adjustment of seats, mirrors, steering wheel, and pedals; headlight vehicle control contexts, including adjustment of high/low beams or fog/accessory lights; wiper vehicle control contexts, including adjustment of front and rear wiper patterns; HVAC vehicle control contexts, including adjustment of heating, defrosting, and air-conditioning; entertainment vehicle control contexts, including adjustment of radio, NFC/Bluetooth connectivity, phone calls, texts, and navigation; and access vehicle control contexts, including raising/lowering windows, manual lock/unlock, remote lock/unlock, child locks, and hood/trunk/fuel door latch control. Any of these can be controlled by any of the dial 40, switch actuators (e.g. 23, 26, 36, 43), end grip 30, or additional controls (dials, switch actuators) provided on the vehicle control 10.

Vehicle control states have been described as belonging to respective vehicle control contexts based on one or more overlapping systems the control states influence, but this is not required. Vehicle control states may alternatively be grouped into vehicle control contexts by frequency of use, a pattern of sequential use, or even user definable relationships.

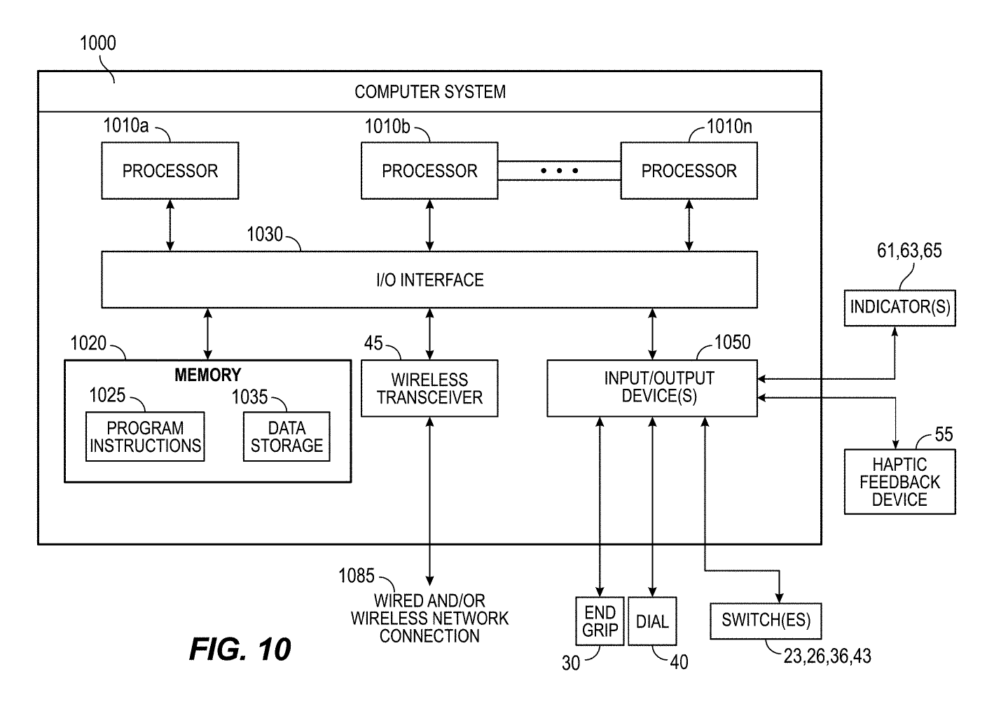

FIG. 10 illustrates a computer system 1000 that may be configured to include or execute any or all of the embodiments described herein. In different embodiments, computer system 1000 may be any of various types of devices, including, but not limited to, an onboard vehicle computer.

Various embodiments of operating a vehicle control state may be executed in one or more computer systems 1000, which may interact with various other devices. It is contemplated that any component, action, or functionality described above with respect to FIGS. 1 through 9 may be implemented on one or more computers configured as computer system 1000 of FIG. 10, according to various embodiments. In the illustrated embodiment, computer system 1000 includes one or more processors 1010 coupled to a system memory 1020 via an input/output (I/O) interface 1030, and one or more input/output devices, which can include one or more user interface (also referred to as “input interface”) devices, such as vehicle control 10. In various embodiments, computer system 1000 may be a uniprocessor system including one processor 1010, or a multiprocessor system including several processors 1010 (e.g. two, four, eight, or another suitable number). Processors 1010 may be any suitable processor capable of executing instructions. For example, in various embodiments processors 1010 may be general-purpose or embedded processors implementing any of a variety of instruction set architectures (ISAs), such as the x86, PowerPC, SPARC, or MIPSISAs, or any other suitable ISA. In multiprocessor systems, each of processors 1010 may commonly, but only necessarily, implement the same ISA.

System memory 1020 may be configured to store program instructions, data, etc. accessible by processor 1010. For example, memory 1020 of computer system 1000 may include executable instructions 1025 for performing various tasks. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions included in memory 1020 may be configured to implement some or all of a system for operating a vehicle control, incorporating any of the functionality described above. Additionally, existing control data of memory 1020 may include any of the information or data structures described above. In some embodiments, program instructions and/or data may be received, sent, or stored upon different types of computer-accessible media or on similar media separate from system memory 1020.

In one embodiment, I/O interface 1030 may be configured to coordinated I/O traffic between processor 1010, system memory 1020, and any peripheral devices in the device, including wireless transceiver 45 or other peripheral interfaces, such as input/output devices 1050. Wireless transceiver 45 may be configured to allow data to be exchanged between computer system 1000 and other devices attached to a network 1085 (e.g., carrier or agent devices). Network 1085 may in various embodiments include one or more networks including but not limited to: CAN bus, LIN bus, Local Area Networks (LANs) (e.g., an Ethernet or corporate intranet), Wide Area Networks (WANs) (e.g., the Internet), wireless data networks, some other electronic data network, or some combination thereof.

Input/output devices may, in some embodiments, include one or more display terminals, keyboards, keypads, touchpads, end grips 30, dials 40, switch actuators (e.g. 23, 26, 36, 43), haptic feedback devices 55, indicators (e.g. 61, 63, 65), scanning devices, voice or optical recognition devices, or any other devices suitable for entering or accessing data by one or more computer systems 1000.

Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

Thus, the disclosure provides, among other things, a multi-function vehicle control. Various features and advantages of the invention are set forth in the following claims.

What is claimed is:

1. A multi-function vehicle control for a vehicle having an interior surface and a transmission, the multi-function vehicle control comprising:
a shifter movable to different positions corresponding to different states of the transmission; and
an elongate base extending from the interior surface in a cross-car direction of the vehicle and defining a driver-facing side, the elongate base movably supporting the shifter for multiple movements of the shifter relative to the elongate base including:
a first movement of the shifter along a longitudinal direction of the elongate base operable to control a first operation of the transmission;
a second movement of the shifter away from the driver-facing side, in a forward vehicle travel direction operable to control a second operation of the transmission; and
a third movement of the shifter toward the driver-facing side, in a rearward vehicle travel direction operable to control a third operation of the transmission.

2. The multi-function vehicle control of claim 1, wherein the multi-function vehicle control is a steering column shifter stalk and the interior surface is a steering column supporting a proximal end of the elongate base.

3. The multi-function vehicle control of claim 1, wherein the first transmission operation controlled by the first shifter movement is engagement or disengagement of a park gear of the transmission.

4. The multi-function vehicle control of claim 1, wherein the second transmission operation controlled by the second shifter movement is engagement of a forward drive state of the transmission.

5. The multi-function vehicle control of claim 1, wherein the third transmission operation controlled by the third shifter movement is engagement of a reverse drive state of the transmission.

6. The multi-function vehicle control of claim 1, further comprising a start/stop actuator supported by the elongate body on the driver-facing side thereof and operable to selectively enable and disable an active motor state that allows the vehicle having the multi-function vehicle control to be driven.

7. The multi-functional vehicle control of claim 6, further comprising a dial supported by the elongate body on the driver-facing side thereof and rotatable about a dial axis to a plurality of rotational positions to change a vehicle control state, wherein the dial is situated about the start/stop actuator.

8. The multi-functional vehicle control of claim 1, further comprising a dial supported by the elongate body on the driver-facing side thereof and rotatable about a dial axis to a plurality of rotational positions to change a vehicle control state.

9. The multi-functional vehicle control of claim 1, wherein the shifter is yieldably detained in a drive position upon the second shifter movement to select a forward drive state of the transmission, and wherein the shifter is yieldably detained in a reverse position upon the third shifter movement to select a reverse drive state of the transmission.

10. The multi-functional vehicle control of claim 9, wherein the first shifter movement moves the shifter into or out of a park position, and the first shifter movement is enabled exclusively from a neutral position located between the drive and reverse positions.

11. The multi-functional vehicle control of claim 9, wherein the shifter and the elongate base define a continuous contoured surface extending across a part line therebetween, wherein the continuous contoured surface is made discontinuous across the part line by movement of the shifter to both the drive position and the reverse position.

12. A multi-function vehicle control for a vehicle having an interior surface and a transmission, the multi-function vehicle control comprising:
a fixed body defining a longitudinal axis; and
a shifter provided with an end grip supported on the fixed body via a connection such that the end grip is movable to different positions corresponding to different states of the transmission,
wherein the end grip is supported to be slidably displaceable along a distal end of the fixed body, and
wherein the connection prohibits rotation of the end grip about the longitudinal axis.

13. The multi-function vehicle control of claim 12, wherein the connection is a hinge or pivot connection defining a pivot axis that is positioned outside of the end grip.

14. The multi-function vehicle control of claim 12, wherein the end grip is yieldably detained in a plurality of positions including a reverse position, a drive position, and a park position.

15. The multi-function vehicle control of claim 14, wherein movement of the end grip to the park position is enabled exclusively from a neutral position located between the drive and reverse positions.

16. The multi-function vehicle control of claim 12, wherein the end grip is movable in a rearward vehicle travel direction to a reverse position, and wherein the end grip is movable in a forward vehicle travel direction to a drive position.

17. The multi-function vehicle control of claim 16, wherein the end grip is movable along the longitudinal axis to a park position.

18. The multi-function vehicle control of claim 12, wherein the connection is a sliding track connection.

19. The multi-function vehicle control of claim 12, wherein the fixed body and the end grip define a continuous contoured surface extending across a part line therebetween, wherein the continuous contoured surface is made discontinuous across the part line by movement of the shifter to both a drive position and a reverse position.

20. A method of electronically shifting among operating states of a vehicle transmission with a shifter, the method comprising:
providing an elongate base extending from a vehicle interior surface and defining a driver-facing side, the elongate base movably supporting the shifter for movement in a fore-aft direction of the vehicle;
displacing the shifter along a longitudinal direction of the elongate base to disengage a park operating state of the transmission;
displacing the shifter away from the driver-facing side, in a forward travel direction of the vehicle to engage a forward drive state of the transmission; and
displacing the shifter toward the driver-facing side, in a rearward travel direction of vehicle, to engage a reverse drive state of the transmission.
